(19) United States
(12) Patent Application Publication
(10) Pub. No.: US 2010/0100662 A1
(43) Pub. Date: Apr. 22, 2010

(54) ACCESSING APPARATUS AND METHOD USING THE SAME

(75) Inventor: Nei-chiung Perng, Yulin (TW)

Correspondence Address: KIRTON AND MCCONKIE, 60 EAST SOUTH TEMPLE,, SUITE 1800, SALT LAKE CITY, UT, 84111, US

(73) Assignee: GENESYS LOGIC, INC., Shindian City (TW)

(21) Appl. No.: 12/407,658

(22) Filed: Mar. 19, 2009

(30) Foreign Application Priority Data
Oct. 21, 2008 (TW) 097140336

(51) Int. Cl. G06F 12/00

(52) U.S. Cl. 711/101; 711/E12.001

(57) ABSTRACT

An accessing apparatus and a method using the same are provided for accessing a non-volatile memory storage device by an external electronic device. The accessing apparatus includes a fixing unit, a transmission interface device, and a transmission media. The transmission interface device has a resilience power interface unit and a data interface unit. One end portion of the transmission media is electrically connected to the transmission interface device. When the external electronic device accesses the non-volatile memory storage device, the transmission media transmits power to the non-volatile memory storage device through the resilience power interface unit for driving the non-volatile memory storage device so that the transmission media is capable of transmitting either an accessing command or an accessing data to the data interface unit.

### TECHNICAL FIELD OF THE INVENTION

The present invention relates to an accessing apparatus and a method using the same, and more particularly to an accessing apparatus and a method for accessing a non-volatile memory storage device having paper-shaped appearance.

### BACKGROUND OF THE INVENTION

A Taiwan Patent No. M336510 issued on Jul. 11, 2008 discloses a non-volatile memory storage device which is a digital storage medium having paper-shaped appearance. The non-volatile memory features data retention when power is off. Besides, the non-volatile memory also features smaller volume, lower power consumption and is not easy to be damaged. FIG. 1 illustrates an exploded stereographic view of the non-volatile memory storage device 10 having paper-shaped appearance. The non-volatile memory storage device 10 includes a top paper layer 110, a bottom paper layer 130 and a flexible printed circuit board (FPCB) 120 packaged between the top paper layer 110 and the bottom paper layer 130. The top paper layer 110 defines a through opening 112. The top paper layer 110 and the bottom paper layer 130 may be made of paper material which can be handwritten thereon.

The flexible printed circuit board (FPCB) 120 includes a transmission interface 121, a non-volatile memory controller 122 and at least one non-volatile memory 123. The transmission interface 121 includes universal serial bus (USB) and is disposed on the flexible printed circuit board (FPCB) 120. The transmission interface 121 is used to electrically connect to an external electronic device (e.g. a personal computer, not shown) via a connector or cable. The transmission interface 121 performs data transfer or reads/writes data from/to the non-volatile memory storage device 10. The non-volatile memory storage device 10 can be powered by an external source (e.g. the external electronic device) via the transmission interface 121, such as universal serial bus (USB). In other words, the non-volatile memory storage device 10 is not powered by itself. Both the non-volatile memory controller 122 and the non-volatile memory 123 are a bare die mounted on the flexible printed circuit board (FPCB) 120 and not packaged. That is, the non-volatile memory controller 122 and the non-volatile memory 123 are not protected by a hard case. As a result, the non-volatile memory storage device 10 has flexibility or elasticity as the traditional paper sheets feature. The non-volatile memory controller 122 complies with external instructions from the external electronic device via the transmission interface 121 to control the non-volatile memory 123 for performing data transmissions between the non-volatile memory storage device 10 and the external electronic device. In practice, the non-volatile memory 123 may have the features of higher or lower memory capacity. The lower memory capacity of non-volatile memory 123 meets low cost and physical file folder-collating requirements. The layout among the transmission interface 121, the non-volatile memory controller 122 and the non-volatile memory 123 on the flexible printed circuit board (FPCB) 120 can be implemented as conventional layouts and detailed descriptions thereof are thus omitted herein.

FIG. 2 illustrates a stereographic view of the non-volatile memory storage device 10 having paper-shaped appearance. The top paper layer 110 bonds the bottom paper layer 130 together to package the flexible printed circuit board (FPCB) 120 therebetween. The through opening 112 of the top paper layer 110 can expose the transmission interface 121 to the outside for convenience of electrically connecting with the external electronic device or an end portion of a cable (not shown). Data transfer between the non-volatile memory storage device 10 and the external electronic device (e.g. a personal computer) can be thereby performed. On the other hand, the non-volatile memory storage device 10 also functions as the traditional paper sheets, including instantly writing, printing and binding.

Consequently, there is a need to develop an accessing apparatus for accessing the non-volatile memory storage device 10 having paper-shaped appearance by an external electronic device.

### SUMMARY OF THE INVENTION

A primary objective of the present invention is to provide an accessing apparatus for accessing a non-volatile memory storage device by an external electronic device. The accessing apparatus is coupled to the non-volatile memory storage and the external electronic device. The accessing apparatus includes a fixing unit, a transmission interface device, and a transmission media. The fixing unit is used for being fixed on the non-volatile memory storage device. The transmission interface device is positioned at the fixing unit and has a resilience power interface unit and a data interface unit. The resilience power interface unit and the data interface unit are used for electrically contacting with the non-volatile memory storage device for accessing the non-volatile memory storage device. One end portion of the resilience power interface unit is fastened on the fixing unit, and the other end portion of the resilience power interface unit is spaced apart the fixing unit for allowing the transmission interface device to be electrically contacted with the non-volatile memory storage device in a resilience status. One end portion of the transmission media is electrically connected to the transmission interface device. When the external electronic device accesses the non-volatile memory storage device, the transmission media transmits power to the resilience power interface unit for driving the non-volatile memory storage device so that the transmission media is capable of transmitting either an accessing command or an accessing data to the data interface unit.

Another objective of the present invention is to provide an accessing method for accessing a non-volatile memory storage device by an external electronic device. The accessing method includes the following steps. A fixing unit of an accessing apparatus is fixed on the non-volatile memory storage device. A resilience power interface unit of a transmission interface of the accessing apparatus electrically contacts with a corresponding power interface of the non-volatile memory storage device. A transmission media of the accessing apparatus transmits power to the corresponding power interface of the non-volatile memory storage device. One end portion of the resilience power interface unit is fastened on the fixing unit, and the other end portion of the resilience power interface unit is spaced apart the fixing unit for allowing the transmission interface device to be electrically contacted with the non-volatile memory storage device in a resilience status. A data interface unit of the transmission interface device of the accessing apparatus electrically contacts with a corresponding data interface of the non-volatile memory storage device. The transmission media of the accessing apparatus transmits either an accessing command or an accessing data to the corresponding data interface of the non-volatile memory storage device.

According to the accessing apparatus and the accessing method of the present invention, the resilience power interface unit of the accessing apparatus electrically contacts with the corresponding power interface of non-volatile memory storage device first for providing power needed when the external electronic device accesses the non-volatile memory storage device, and then the data interface unit of the accessing apparatus transmits data between the external electronic device and the non-volatile memory storage device. Accordingly, the present invention is used for accessing a non-volatile memory storage device having paper-shaped appearance by an external electronic device.

### BRIEF DESCRIPTION OF THE DRAWINGS

FIG. 1 illustrates an exploded stereographic view of the paper-shaped non-volatile memory storage device having paper-shaped appearance;

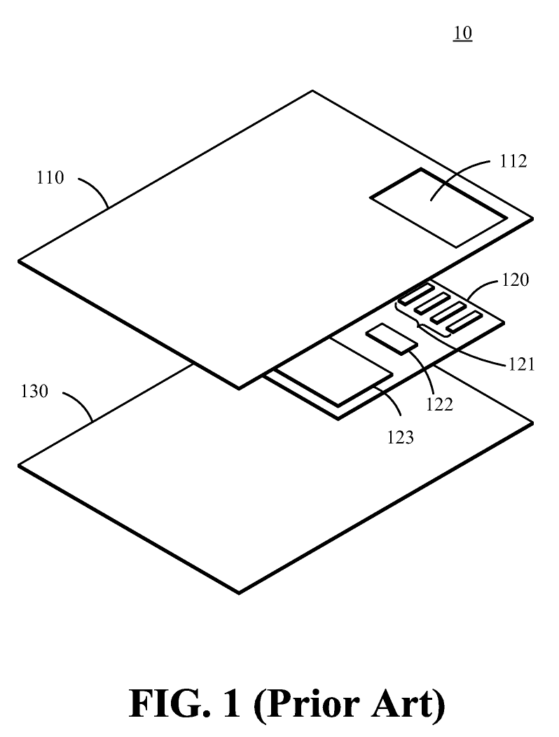

FIG. 2 illustrates a stereographic view of the non-volatile memory storage device;

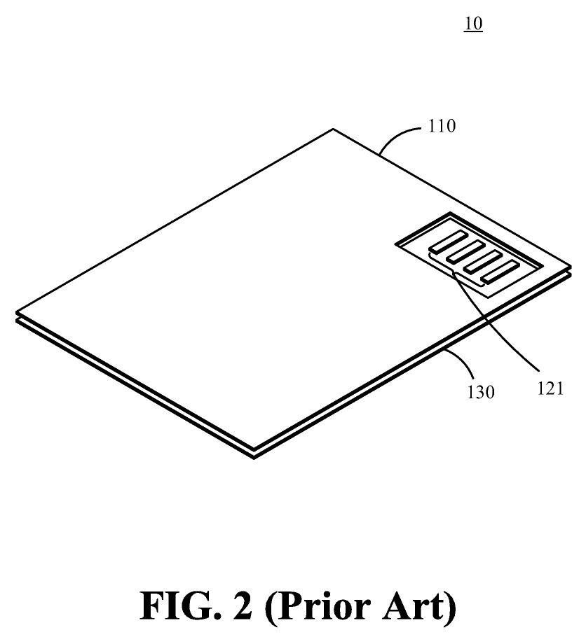

FIG. 3 illustrates an accessing apparatus according to a first embodiment of the present invention;

FIG. 4A and FIG. 4B illustrate the accessing apparatus which is fixed on a non-volatile memory storage device in FIG. 3 according to one embodiment of the present invention;

FIG. 5 illustrates an accessing apparatus according to a second embodiment of the present invention;

FIG. 6A and FIG. 6B illustrate the accessing apparatus which is fixed on a non-volatile memory storage device in FIG. 5 according to one embodiment of the present invention; and

FIG. 7 illustrates a flow chart of an accessing method of an accessing apparatus according to one embodiment of the present invention.

### DETAILED DESCRIPTION OF THE INVENTION

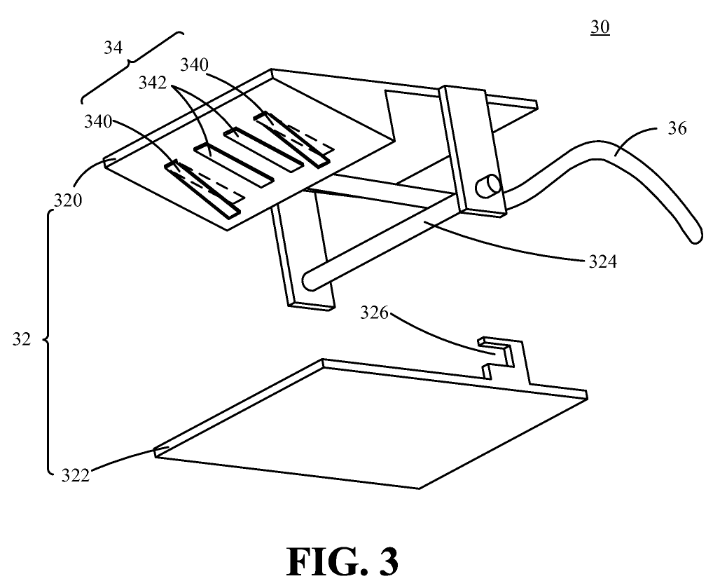

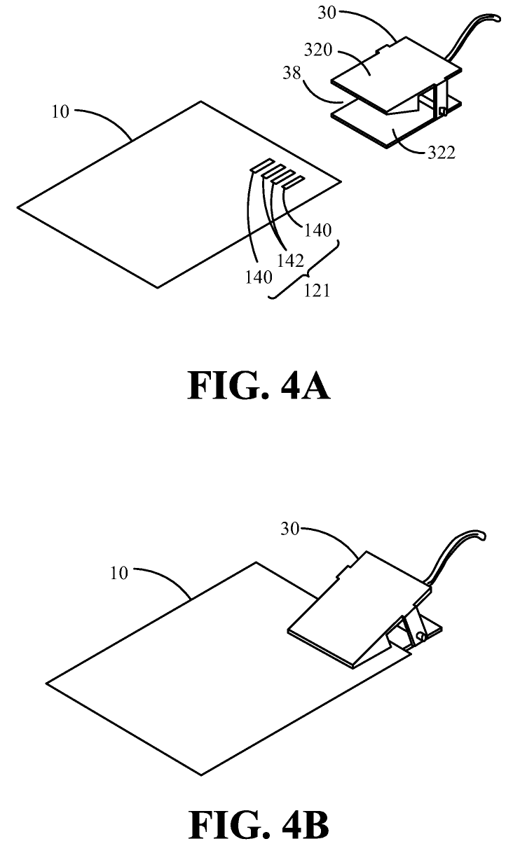

Please refer to FIG. 3, FIG. 4A and FIG. 4B. FIG. 3 illustrates an accessing apparatus 30 according to a first embodiment of the present invention. FIG. 4A and FIG. 4B illustrate the accessing apparatus 30 which is fixed on a non-volatile memory storage device 10 in FIG. 3 according to one embodiment of the present invention. The accessing apparatus 30 includes a fixing unit 32, a transmission interface device 34 and a transmission media 36. The fixing unit 32 includes a top plate 320 and a bottom plate 322. A bar 324 of the top plate 320 is used for buckling into a slot 326 of the bottom plate 322 and serves as a clamp. The transmission interface device 34 is positioned at the top plate 320 which has a protruding triangularly shaped structure. In this embodiment, the transmission interface device 34 includes a resilience power interface unit 340 and a data interface unit 342, which both are a plurality of electrical terminals based on universal serial bus (USB) interface. One end portion of the resilience power interface unit 340 is fastened on the fixing unit 32. The other end portion of the resilience power interface unit 340 is spaced apart the fixing unit 32. As a result, the transmission interface device 34 can be electrically contacted with the non-volatile memory storage device 10 in a resilience status. In one embodiment, it is noted that the transmission interface device 34 are electrical terminals based on any of communication protocol standard. The number and the arrangement of the transmission interface device 34 depend on definitions of any of communication protocol standard. One end portion of the transmission media 36 is electrically connected to the transmission interface device 34.

When an external electronic device (not shown) accesses the non-volatile memory storage device 10, the transmission media 36, e.g. universal serial bus (USB) interface is electrically connected to the external electronic device having universal serial bus (USB) interface. The side which is opposite to the protruding triangularly shaped structure of the top plate 320 is pressed down, and an opening 38 (FIG. 4A) between the top plate 320 and the bottom plate 322 is formed. The non-volatile memory storage device 10 is inserted in the opening 38. The transmission interface device 34 of the accessing apparatus 30 is either exactly or approximately aligned to a transmission interface 121 of the non-volatile memory storage device 10, and the top plate 320 and the bottom plate 322 are clipped on two sides of the non-volatile memory storage device 10 respectively. Because the resilience power interface unit 340 is in the resilience state, the resilience power interface unit 340 electrically contacts with a corresponding interface of the non-volatile memory storage device 10 prior to the data interface unit 342 in the above-mentioned fixing process of the accessing apparatus 30. That is, when the external electronic device accesses the non-volatile memory storage device 10, the transmission media 36 transmits power provided by the external electronic device to a corresponding power interface 140 of the non-volatile memory storage device 10 through the resilience power interface unit 340 of the accessing apparatus 30. After the corresponding power interface 140 and the resilience power interface unit 340 electrically contact with each other, the data interface unit 342 of the accessing apparatus 30 electrically contacts with a corresponding data interface 142 of the non-volatile memory storage device 10. The external electronic device transmits an accessing command to the non-volatile memory storage device 10 through the accessing apparatus 30. In another aspect, the external electronic device writes data in the non-volatile memory storage device 10 or reads data from the non-volatile memory storage device 10, through the accessing apparatus 30.

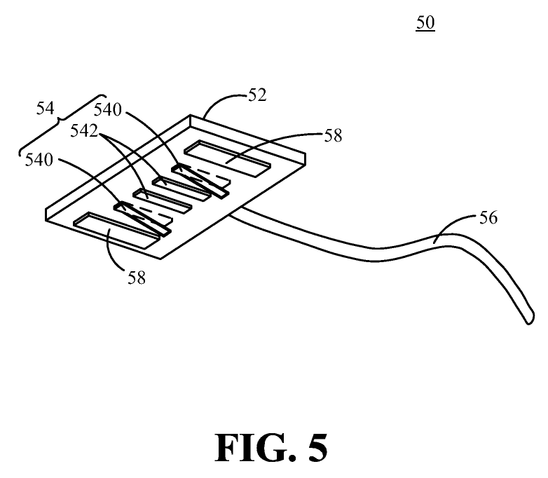

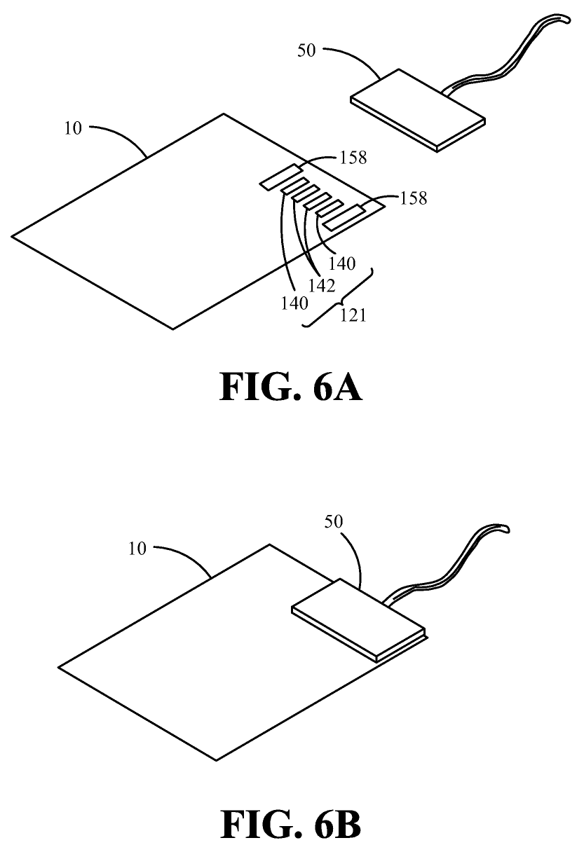

FIG. 5 illustrates an accessing apparatus 50 according to a second embodiment of the present invention. FIG. 6A and FIG. 6B illustrate the accessing apparatus 50 which is fixed on a non-volatile memory storage device in FIG. 5 according to one embodiment of the present invention. The accessing apparatus 50 includes a fixing unit 52, a transmission interface device 54 and a transmission media 56. The fixing unit 52 is a flat plate structure, and magnets 58 are disposed on one side of the flat plate structure for magnetically attracting to the non-volatile memory storage device 10 for attaching the accessing apparatus 50 to the non-volatile memory storage device 10. The transmission interface device 54 is disposed on the same side with the magnets 58. In this embodiment, the transmission interface device 54 includes a resilience power interface unit 540 and a data interface unit 542, which both are a plurality of electrical terminals based on universal serial bus (USB) interface. One end portion of the resilience power interface unit 540 is fastened on the fixing unit 52. The other end portion of the resilience power interface unit 540 is spaced apart the fixing unit 52. As a result, the transmission interface device 54 can be electrically contacted with the non-volatile memory storage device 10 in a resilience status. In one embodiment, it is noted that the transmission interface device 54 are electrical terminals based on any of communication protocol standard. The number and the arrangement of the transmission interface device 54 depend on definitions of any of communication protocol standard. One end portion of the transmission media 56 is electrically connected to the transmission interface device 54.

When an external electronic device (now shown) accesses the non-volatile memory storage device 10, the transmission media 56, e.g. universal serial bus (USB) interface, is electrically connected to the external electronic device having universal serial bus (USB) interface. The magnets 58 of the accessing apparatus 50 are exactly or approximately aligned to sheet metals 158 which are disposed on the non-volatile memory storage device 10 to be corresponding to the magnets 58. Therefore, a goal to fix the accessing apparatus 50 on the non-volatile memory storage device 10 is achieved. Because the resilience power interface unit 540 is in the resilience state, the resilience power interface unit 340 electrically contacts a corresponding power interface 140 of the non-volatile memory storage device 10 prior to the data interface unit 542 in the above-mentioned fixing process of the accessing apparatus 50. That is, when the external electronic device accesses the non-volatile memory storage device 10, the transmission media 56 transmits power provided by the external electronic device to the corresponding power interface 140 of the non-volatile memory storage device 10 through the resilience power interface unit 540 of the accessing apparatus 50. After the corresponding power interface 140 and the resilience power interface unit 540 electrically contact with each other, the data interface unit 542 of the accessing apparatus 50 electrically contacts with a corresponding data interface 142 of the non-volatile memory storage device 10. The external electronic device transmits an accessing command to the non-volatile memory storage device 10 through the accessing apparatus 30. In another aspect, the external electronic device writes data in the non-volatile memory storage device 10 or reads data from the non-volatile memory storage device 10, through the accessing apparatus 50.

The numbers of the magnets 58 and the sheet metals 158 can be adequately adjusted according to firmness requirements. In addition, the sheet metals 158 may be disposed on the fixing unit 52 of the accessing apparatus 50, and the magnets 58 may be disposed on a corresponding location of the non-volatile memory storage device 10. Accordingly, the above-mentioned goal to fix the accessing apparatus 50 on the non-volatile memory storage device 10 can also be achieved by magnetically attracting between the magnets 58 and the sheet metals 158.

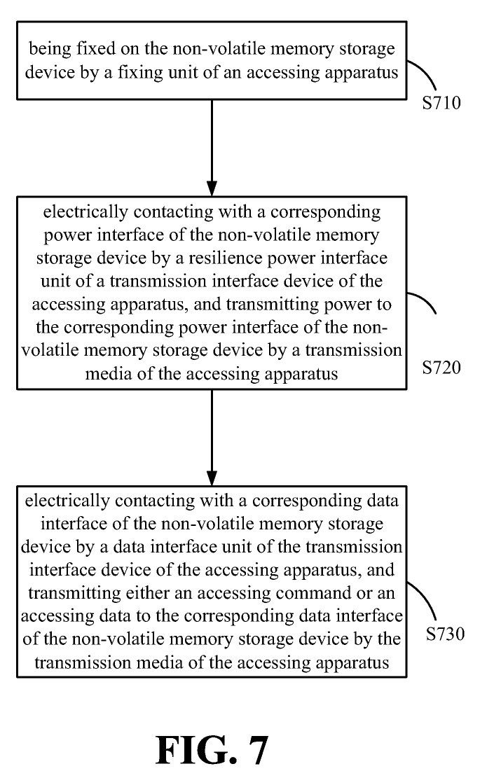

FIG. 7 illustrates a flow chart of an accessing method of an accessing apparatus according to one embodiment of the present invention. The accessing method for accessing a non-volatile memory storage device by an external electronic device includes the following steps.

In step S710, a fixing unit of the accessing apparatus is fixed on the non-volatile memory storage device.

In step S720, a resilience power interface unit of a transmission interface of the accessing apparatus electrically contacts with a corresponding power interface of the non-volatile memory storage device. A transmission media of the accessing media transmits power to the corresponding power interface of the non-volatile memory storage device. One end portion of the resilience power interface unit is fastened on the fixing unit. The other end of the resilience power interface unit is spaced apart the fixing unit. As a result, the transmission interface device can be electrically contacted with the non-volatile memory storage device in a resilience status.

In step S730, a data interface unit of the accessing apparatus electrically contacts with a corresponding data interface of the non-volatile memory storage device. The transmission media of the accessing apparatus transmits either an accessing command or an accessing data to the corresponding data interface of the non-volatile memory storage device.

In one embodiment, the fixing unit includes a top plate and a bottom plate. When the accessing apparatus is fixed on the non-volatile memory storage device, the top plate and the bottom plate both are clipped on two sides of the non-volatile memory storage device respectively.

In another embodiment, the fixing unit is a flat plate structure, and at least one magnet is disposed on one side of the flat plate structure. When the fixing unit is fixed on the non-volatile memory storage device, at least one sheet metal is disposed on the non-volatile memory storage device to be corresponding to the magnet so as to magnetically attract to the accessing apparatus. Therefore, the accessing apparatus is attached to the non-volatile memory storage device.

In another embodiment, the fixing unit is a flat plate structure, and at least one sheet metal is disposed on one side of the flat plate structure. When the fixing unit is fixed on the non-volatile memory storage device, at least one magnet is disposed on the non-volatile memory storage device to be corresponding to the sheet metal so as to magnetically attract to the accessing apparatus. Therefore, the accessing apparatus is attached to the non-volatile memory storage device.

The resilience power interface unit and the data interface unit are a plurality of electrical terminals based on a communication protocol standard, for example, universal serial bus (USB) interface. The electrical terminals of the resilience power interface unit are a plurality of leaf springs.

The transmission media is an interface which is based on the external electronic device for being electrically connected to the external electronic device. Because the resilience power interface unit is in the resilience state, the resilience power interface unit electrically contacts with a corresponding power interface of the non-volatile memory storage device prior to the data interface unit in the above-mentioned fixing process of the accessing apparatus. That is, when the external electronic device accesses the non-volatile memory storage device, the transmission media transmits power provided by the external electronic device to the corresponding power interface of the non-volatile memory storage device through the resilience power interface unit of the accessing apparatus. After the corresponding power interface of the non-volatile memory storage device and the resilience power interface unit of the accessing apparatus electrically contact with each other, the data interface unit of the accessing apparatus electrically contacts with a corresponding data interface of the non-volatile memory storage device. The external electronic device transmits an accessing command to the non-volatile memory storage device through the accessing apparatus. In another aspect, the external electronic device writes data in the non-volatile memory storage device or reads data from the non-volatile memory storage device, through the accessing apparatus.

According to the accessing apparatus and the accessing method of the present invention, the resilience power interface unit of the accessing apparatus electrically contacts with the corresponding power interface of non-volatile memory storage device first for providing power needed when the external electronic device accesses the non-volatile memory storage device. Then the data interface unit of the accessing apparatus transmits data between the external electronic device and the non-volatile memory storage device. Accordingly, the present invention is used for accessing a non-volatile memory storage device having paper-shaped appearance by an external electronic device.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. An accessing apparatus for accessing a non-volatile memory storage device by an external electronic device, wherein the accessing apparatus is coupled to the non-volatile memory storage device and the external electronic device, the accessing apparatus comprising:
a fixing unit, for being fixed on the non-volatile memory storage device;
a transmission interface device positioned at the fixing unit and having a resilience power interface unit and a data interface unit, for electrically contacting with the non-volatile memory storage device for accessing the non-volatile memory storage device, wherein one end portion of the resilience power interface unit is fastened on the fixing unit, and the other end portion of the resilience power interface unit is spaced apart the fixing unit for allowing the transmission interface device to be electrically contacted with the non-volatile memory storage device in a resilience status; and
a transmission media electrically connected to the transmission interface device,
wherein when the external electronic device accesses the non-volatile memory storage device, the transmission media transmits power to the resilience power interface unit for driving the non-volatile memory storage device so that the transmission media is capable of transmitting either an accessing command or an accessing data to the data interface unit.

2. The accessing apparatus of claim 1, wherein the fixing unit comprises a top plate and a bottom plate, and the top plate and the bottom plate both are clipped on two sides of the non-volatile memory storage device respectively when the accessing apparatus is fixed on the non-volatile memory storage device.

3. The accessing apparatus of claim 1, wherein the fixing unit is a flat plate structure, and at least one magnet is disposed on one side of the flat plate structure for magnetically attracting to the non-volatile memory storage device.

4. The accessing apparatus of claim 3, wherein at least one sheet metal is disposed on the non-volatile memory storage device to be corresponding to the magnet when the fixing unit is fixed on the non-volatile memory storage device.

5. The accessing apparatus of claim 1, wherein the fixing unit is a flat plate structure, and at least one sheet metal is disposed on one side of the flat plate structure to be fixed on the non-volatile memory storage device.

6. The accessing apparatus of claim 5, wherein at least one magnet is disposed on the non-volatile memory storage device for magnetically attracting to the sheet metal when the fixing unit is fixed on the non-volatile memory storage device.

7. The accessing apparatus of claim 1, wherein the resilience power interface unit and the data interface unit are a plurality of electrical terminals based on a communication protocol standard, and the electrical terminals of the resilience power interface unit are a plurality of leaf springs.

8. The accessing apparatus of claim 1, wherein the transmission media is an interface which is based on the external electronic device for being electrically connected to the external electronic device.

9. The accessing apparatus of claim 1, wherein the accessing command is generated by the external electronic device.

10. The accessing apparatus of claim 1, wherein the accessing data are either written in the non-volatile memory storage device by the external electronic device or read from the non-volatile memory storage device.

11. An accessing method for accessing a non-volatile memory storage device by an external electronic device, the method comprising steps of:
being fixed on the non-volatile memory storage device by a fixing unit of an accessing apparatus;
electrically contacting with a corresponding power interface of the non-volatile memory storage device by a resilience power interface unit of a transmission interface device of the accessing apparatus, and transmitting power to the corresponding power interface of the non-volatile memory storage device by a transmission media of the accessing apparatus, wherein one end portion of the resilience power interface unit is fastened on the fixing unit, and the other end portion of the resilience power interface unit is spaced apart the fixing unit for allowing the transmission interface device to be electrically contacted with the non-volatile memory storage device in a resilience status; and
electrically contacting with a corresponding data interface of the non-volatile memory storage device by a data interface unit of the transmission interface device of the accessing apparatus, and transmitting either an accessing command or an accessing data to the corresponding data interface of the non-volatile memory storage device by the transmission media of the accessing apparatus.

12. The accessing method of claim 11, wherein the fixing unit comprises a top plate and a bottom plate, and the top plate and the bottom plate are both clipped on two sides of the non-volatile memory storage device respectively when the accessing apparatus is fixed on the non-volatile memory storage device.

13. The accessing method of claim 11, wherein the fixing unit is a flat plate structure, and at least one magnet is disposed on one side of the flat plate structure for magnetically attracting to the non-volatile memory storage device.

14. The accessing method of claim 13, wherein at least one sheet metal is disposed on the non-volatile memory storage device to be corresponding to the magnet when the fixing unit is fixed on the non-volatile memory storage device.

15. The accessing method of claim 11, wherein the fixing unit is a flat plate structure, and at least one sheet metal is disposed on one side of the flat plate structure to be fixed on the non-volatile memory storage device.

16. The accessing method of claim 15, wherein at least one magnet is disposed on the non-volatile memory storage device for magnetically attracting to the sheet metal when the fixing unit is fixed on the non-volatile memory storage device.

17. The accessing method of claim 11, wherein the resilience power interface unit and the data interface unit are a plurality of electrical terminals based on a communication protocol standard, and the electrical terminals of the resilience power interface unit are a plurality of leaf springs.

18. The accessing method of claim 11, wherein the transmission media is an interface which is based on the external electronic device for being electrically connected to the external electronic device.

19. The accessing method of claim 11, wherein the accessing command is generated by the external electronic device.

20. The accessing method of claim 11, wherein the accessing data are either written in the non-volatile memory storage device by the external electronic device or read from the non-volatile memory storage device.
